(19) United States
(12) Patent Application Publication
(10) Pub. No.: US 2009/0110314 A1
(43) Pub. Date: Apr. 30, 2009

(54) IMAGE PROCESSING APPARATUS AND IMAGE PROCESSING METHOD

(75) Inventors: Kazumasa Miyazaki, Tokyo (JP); Masaharu Nagata, Tokyo (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/261,522

(22) Filed: Oct. 30, 2008

(30) Foreign Application Priority Data
Oct. 31, 2007 (JP) 2007-283833

(51) Int. Cl. G06K 9/36

(52) U.S. Cl. 382/243

(57) ABSTRACT

An image processing apparatus including: a decoder; an image size processor that executes image processing regarding an image size on uncompressed image data as the output from the decoder; a general-use interface that transfers the output from the decoder or the image size processor; an exclusive-use interface that transfers the output from the decoder or the image size processor an image synthesis processor that generates uncompressed image data of a composite image for display of a small image size by image synthesis on the basis of uncompressed image data transferred through the exclusive-use interface, and generates uncompressed image data of a composite image for printing or storage of a large image size by image synthesis on the basis of uncompressed image data transferred through the general-use or the exclusive-use interface; and an encoder that compresses uncompressed image data of the generated composite image for printing or storage.

### CROSS REFERENCES TO RELATED APPLICATIONS

The present invention contains subject matter related to Japanese Patent Application JP 2007-283833 filed in the Japanese Patent Office on Oct. 31, 2007, the entire contents of which being incorporated herein by reference.

### BACKGROUND OF THE INVENTION

1. Field of the Invention

The present invention relates to an image processing apparatus and an image processing method for use in generating a composite image constituting an image collection, such as a scrapbook, on the basis of still images, such as photographic images, and displaying on a display and printing by a printer or storing in a storage device the generated composite image.

2. Description of the Related Art

When image data is output to an image output unit, such as an image display unit, after being processed by an image processor, the mode of practice of image processing is changed depending on the transmission speed of the transmission line or the processing capability of the image output unit in various kinds of image processing.

For example, JP-A-2007-264903 discloses a technology in which when image data is compressed by a computer, compressed image data is transmitted to a projector through a transmission line having a USB interface and a USB cable and extended by the projector, and an image is displayed, the transmission speed of the transmission line is measured, and a compression method is determined in accordance with the measurement result.

### SUMMARY OF THE INVENTION

The method disclosed in JP-A-2007-264903 relates to image processing when consecutive images are displayed in real time. Alternatively, a technology for generating a composite image constituting an image collection, such as a scrapbook, on the basis of still images, such as photographic images, and displaying on a display and printing by a printer or storing in a storage device the composite image may be considered.

In this case, unlike the method disclosed in JP-A-2007-264903, in which image data is simply transferred in real time, a different point of view regarding an image size may be needed.

Specifically, in respects to a composite image for display, even when image data of the composite image is output to an HDTV (High Definition Television) receiver and the composite image is displayed on a display of the HDTV receiver, it is only necessary to generate a composite image of a relatively small size, such as 1920×1080 pixels. In addition, when a user instructs to generate the composite image, preferably, the composite image for display is immediately displayed on the display.

For this reason, in generating the composite image for display, if image data is compressed, preferably, a still image, such as a photographic image, from which the composite image is generated is extended to an image size for display, such as 1920×1080 pixels, to the maximum. And, uncompressed image data is preferably transferred to an image processor, which executes image processing regarding image synthesis, through an exclusive-use interface capable of transferring uncompressed image data of 1920×1080 pixels in image size in real time, not general-use interface, such as USB (Universal Serial Bus) or PCI (Peripheral Component Interconnect), thereby generating the composite image for display.

Meanwhile, in respects to a composite image for printing or storage, a still image, such as a photographic image, of an image size beyond 10 million pixels is demanded, and preferably, a composite image of an image size beyond 10 million pixels is preferably generated. In addition, when the user instructs to generate a composite image, the composite image for printing or storage is generated for printing or storage, without being displayed on the display.

For this reason, in generating a composite image for printing or storage, if image data is compressed, a still image, such as a photographic image, from which the composite image is generated needs to be extended. And, uncompressed image data needs to be transferred to the image processor, which executes image processing, such as image synthesis, through the general-use interface, such as USB or PCI, not the exclusive-use interface, thereby generating the composite image for printing or storage.

Thus, it is desirable to generate a composite image for display and a composite image for printing or storage so as to satisfy demands for readiness regarding the composite image for display and increase in size regarding the composite image for printing or storage with simple configuration and processing.

According to an embodiment of the invention, an image processing apparatus includes a decoder that extends compressed image data of a still image to be synthesized, an image size processor that executes image processing regarding an image size on uncompressed image data as the output from the decoder, a general-use interface that transfers uncompressed image data as the output from the decoder or the image size processor, and has a relatively low transmission speed, an exclusive-use interface that transfers uncompressed image data as the output from the decoder or the image size processor, and has a relatively high transmission speed, an image synthesis processor that generates uncompressed image data of a composite image for display of a relatively small image size by image synthesis on the basis of uncompressed image data transferred through the exclusive-use interface, and generates uncompressed image data of a composite image for printing or storage of a relatively large image size by image synthesis on the basis of uncompressed image data transferred through the general-use interface or the exclusive-use interface, and an encoder that compresses uncompressed image data of the generated composite image for printing or storage.

With this image processing apparatus, in generating the composite image for display, the image synthesis processor generates the composite image for display on the basis of uncompressed image data transferred through the exclusive-use interface capable of transferring uncompressed image data of a relatively small image size, such as 1920×1080 pixels, in real time. Therefore, when the user instructs to generate a composite image, the composite image for display is immediately displayed on a display.

Meanwhile, in generating the composite image for printing or storage, for example, uncompressed image data of the still image to be synthesized is transmitted to the image synthesis processor through the general-use interface, without being divided, and the composite image for printing or storage is generated. Therefore, it is possible to generate a composite image of a large image size as the composite image for printing or storage.

To this end, what is necessary is that a codec section including the image size processor and the image synthesis processor are connected with each other through the general-use interface and the exclusive-use interface.

### BRIEF DESCRIPTION OF THE DRAWINGS

FIG. 1 is a diagram illustrating an example of an image system including an example of an image processing apparatus according to an embodiment of the invention;

FIG. 2 is a diagram illustrating examples of a scrapbook and a composite image;

FIG. 3 is a diagram illustrating an example of a series of processing regarding generation and display of a composite image for display, which is executed by an image processing apparatus;

FIGS. 4A and 4C are diagrams illustrating a process of generation of a composite image for display;

FIG. 5 is a diagram illustrating a part of a series of processing regarding generation and printing or storage of a composite image for printing or storage, which is executed by an image processing apparatus;

FIG. 6 is a diagram illustrating a part of a series of processing regarding generation and printing or storage of a composite image for printing or storage, which is executed by an image processing apparatus;

FIGS. 7A to 7C are diagrams illustrating a process of generation of a composite image for printing or storage;

FIG. 8 is a diagram illustrating a case where in generating a composite image for printing or storage, a photographic image is divided and transferred; and

FIG. 9 is a diagram illustrating a case where in generating a composite image for printing or storage, a composite image is divided and transferred.

### DETAILED DESCRIPTION OF THE INVENTION

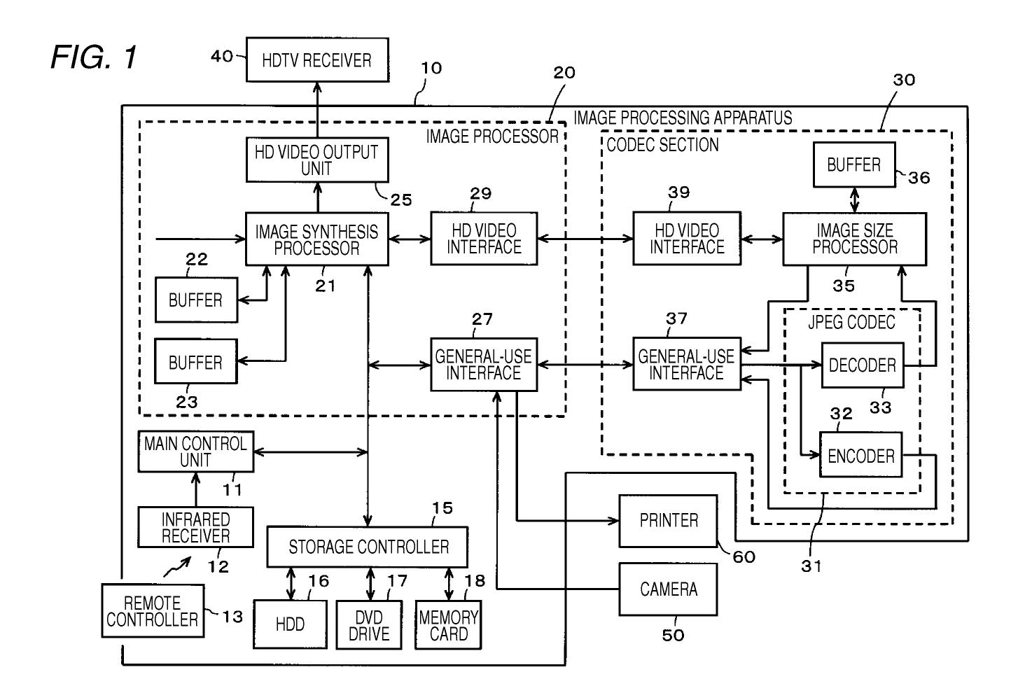

### [1. Example of Image System and Image Processing Apparatus: FIG. 1]

FIG. 1 illustrates an example of an image system including an example of an image processing apparatus according to an embodiment of the invention.

In the image system of this example, an HDTV receiver 40, a camera 50, and a printer 60 are connected to an image processing apparatus 10.

The HDTV receiver 40 has a tuner capable of receiving HDTV broadcasting and an HDTV-compliant display of 1920×1080 pixels, and is connected to the image processing apparatus 10 by an HDMI (Registered Trademark, High-Definition Multimedia Interface) cable.

The camera 50 is an imaging device, such as a digital camera, capable of capturing an image of a subject and compressing the image in a recording medium, such as a memory case, in forms of a JPEG (Joint Photograph Experts Group) compressed image file. The camera 50 is connected to the image processing apparatus 10 by a USB cable.

The printer 60 is also connected to the image processing apparatus 10 by a USB cable.

The image processing apparatus 10 includes a main controller 11, a storage controller 15, an image processor 20, and a codec section 30.

The main controller 11 controls the entire image processing apparatus 10, and includes a CPU, a ROM, and a RAM.

Connected to the main controller 11 is an infrared receiver 12 that receives an infrared remote control signal from a remote controller 13 associated with the image processing apparatus 10.

The storage controller 15 controls an HDD (Hard Disc Drive) 16 and a DVD drive 17 in the image processing apparatus 10 and a memory card 18 installed in the image processing apparatus 10 under the control of the main controller 11.

A hard disc in the HDD 16 stores beforehand programs, such as a system program or an image processing engine, and JPEG files of base-sheet images from which a composite image is generated. In addition, in the hard disc of the HDD 16, a user records JPEG files of still images, such as photographic images, and the image processing apparatus 10 records JPEG files of composite images for printing or storage, as described below.

The memory card 18 is installed in, for example, the camera 50, and records JPEG compressed image data or uncompressed image data of images of the subject captured by the camera 50.

The image processor 20 includes an image synthesis processor 21, an HD video output unit 25, a general-use interface 27, and an HD video interface 29. The codec section 30 includes a JPEG codec 31 having an encoder 32 and a decoder 33, an image size processor 35, a general-use interface 37, and an HD video interface 39.

The image synthesis processor 21 generates a composite image for display of a 1920×1080 pixels in image size by using a buffer 22 for image expansion, and outputs uncompressed image data of the composite image for display to the HD video output unit 25. Further, the image synthesis processor 21 generates a composite image for printing or storage of an image size larger than 1920×1080 pixels by using a buffer 23 for image expansion, and transfers uncompressed image data of the composite image for printing or storage to the codec section 30.

The image size processor 35 imports uncompressed image data extended by the decoder 33, performs processing regarding an image size, such as scaling or trimming, by using a buffer 36, and transfers uncompressed image data after being processed to the image synthesis processor 21 of the image processor 20.

The general-use interface 27 of the image processor 20 and the general-use interface 37 of the codec section 30 are USB or PCI, and form a host bus between the image processor 20 and the codec section 30. The HD video interface 29 of the image processor 20 and the HD video interface 39 of the codec section 30 is an exclusive-use interface capable of transferring uncompressed image data of 1920×1080 pixels in image size for HDTV in real time, and form an exclusive-use bus between the image processor 20 and the codec section 30.

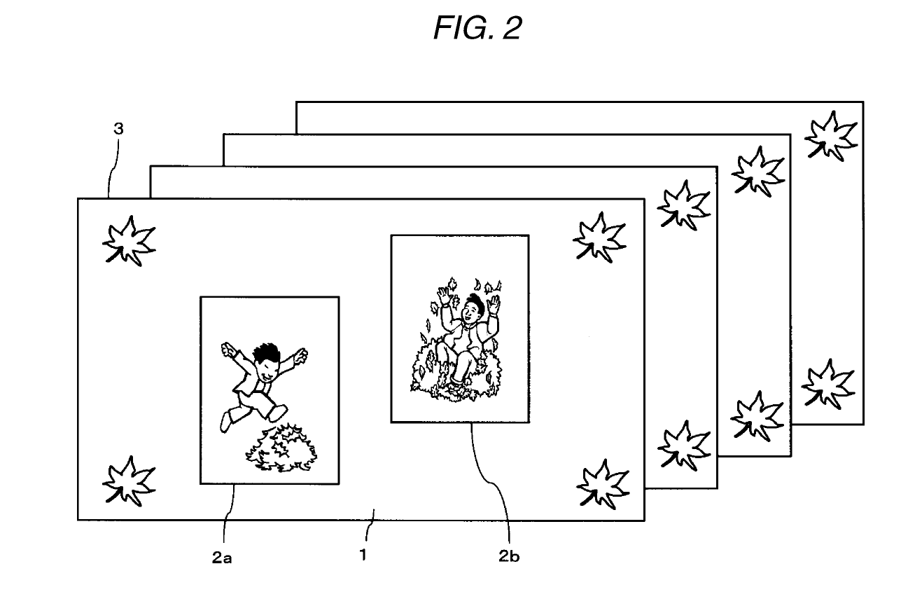

### [2. Generation of Composite Image: FIGS. 2 to 9]

In the image processing apparatus 10 of the example shown in FIG. 1, for example, if the memory card 18 is inserted into a card slot of the image processing apparatus 10 and an import button of the remote controller 13 is pressed, the image processing apparatus 10 imports compressed image data or uncompressed image data of an image recorded in the memory card 18 and records imported image data in the HDD 16.

In this case, the main controller 11 discriminates from information, such as a camera model name or imaging date and time, recorded in the memory card 18 in association with image files when imaging whether or not the image files recorded in the memory card 18 are all recorded in the HDD 16, and only records in the HDD 16 image files, which are not recorded in the HDD 16.

The main controller 11 groups multiple images imported into the HDD 16 by event, such as imaging date of each image, and stores the grouped images as an album by event.

If the user instructs to create a scrapbook by using the remote controller 13, the image processing apparatus 10 generates the composite image for display and the composite image for printing or storage as follows.

### (2-1. Scrapbook and Composite Image: FIG. 2)

As shown in FIG. 2, a scrapbook has one or a plurality of composite images 3 in which images 2a and 2b imported from the memory card 18 into the HDD 16 are converted to be of an appropriate image size and pasted to a base-sheet image (wallpaper image) 1 prepared in the HDD 16 beforehand.

In respects to the base-sheet image 1, various kinds of colors or pictures, such as spring, summer, fall, and winter, are prepared. The main controller 11 appropriately selects one from among various kinds of colors or pictures on the basis of information, such as imaging date, attached to the image files of the images imported into the HDD 16.

The image are pasted to the base-sheet image 1 by two, but when the images to be pasted are 9 in total, one or three images are pasted to one page of the base-sheet image.

The main controller 11 determines which page of the base-sheet image and which region an image is pasted to, without depending on the user's instruction. And, the main controller 11 generates as a design template information specifying a base-sheet image and information representing images pasted to each page of the base-sheet image and the size and position of a region where each image is pasted.

When a plurality of composite images are generated as a scrapbook, a plurality of composite images are individually generated in respects to the composite image for display and the composite image for printing or storage. Meanwhile, in respects to a composite image for printing or storage, a plurality of composite images may be sequentially generated and printed or stored, and in respects to a composite image for display, only a composite image of a first page may be generated and displayed.

In this case, it is possible for the user to confirm on the display of the HDTV receiver 40 what kind of scrapbook is created. This will be described in reference to the following example.

In this case, a composite image for display is generated before a composite image for printing or storage, and a composite image for display is stored in the buffer 22 and continuously displayed on the display of the HDTV receiver 40 while a composite image for printing or storage is generated.

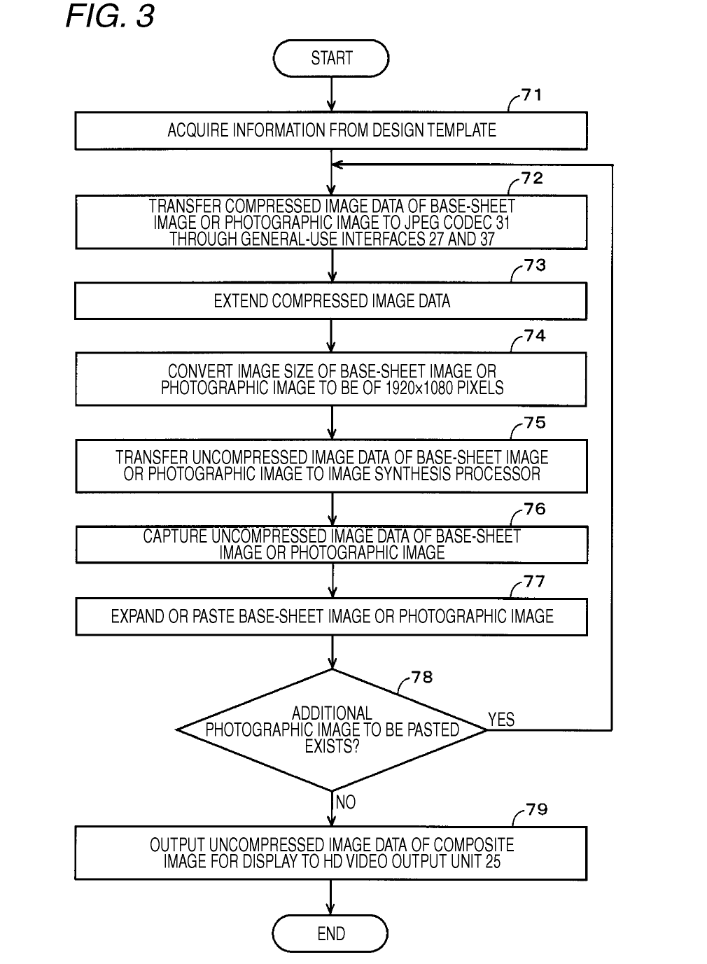

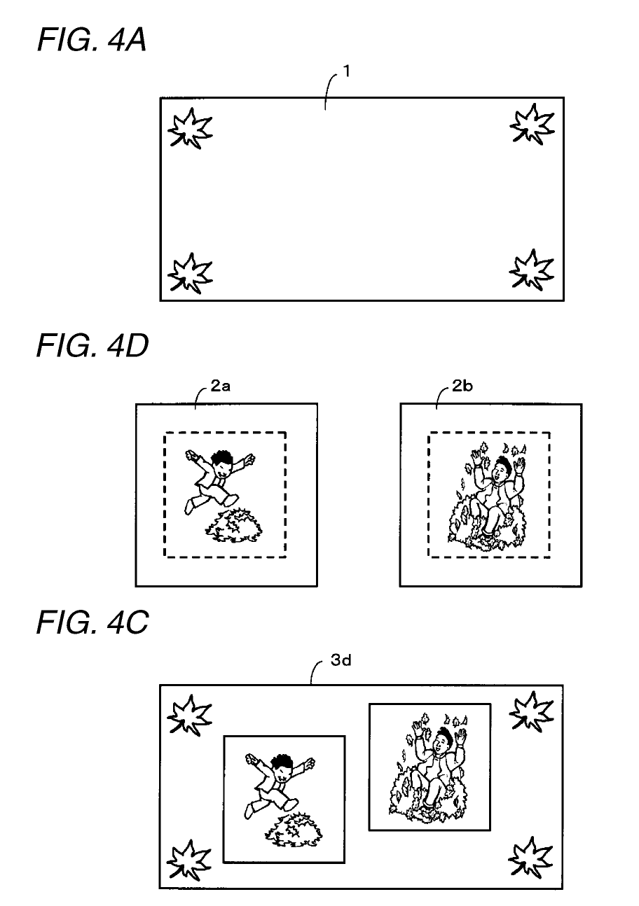

### (2-2. Example of Generation of Composite Image for Display: FIGS. 3 and 4)

FIG. 3 shows an example of a series of processing regarding generation and display of a composite image for display, which is executed by the image processing apparatus 10.

In this example, as described above, after the design template is generated, at Step 71, the main controller 11 first acquires information about a composite image of a first page from the design template. Next, at Step 72, the main controller 11 initially transfers compressed image data (JPEG file) of the base-sheet image 1 shown in FIG. 4A to the JPEG codec 31 through the general-use interfaces 27 and 37.

Next, at Step 73, the decoder 33 of the JPEG codec 31 extends compressed image data. Next, at Step 74, the image size processor 35 converts the image size of the base-sheet image represented by extended uncompressed image data to be 1920×1080 pixels or less. Next, at Step 75, the image size processor 35 transfers uncompressed image data of the base-sheet image to the image synthesis processor 21 through the HD video interfaces 39 and 29.

Next, at Step 76, the image synthesis processor 21 captures uncompressed image data of the base-sheet image, and at Step 77, expands the base-sheet image onto the buffer 22 as a first stage of image synthesis.

Next, at Step 78, the image synthesis processor 21 determines whether or not an additional image to be pasted exists, and when no additional image to be pasted exists, the process progresses from Step 78 to Step 79. Meanwhile, when an additional image to be pasted exists, the process returns (progresses) from Step 78 to Step 72, and Steps 72 to 77 are executed for the image to be pasted.

In respects to the images 2a and 2b to be pasted shown in FIG. 4B, at Step 74, the image size processor 35 reduces the image size of each image represented by uncompressed image data after being extended to an image size of 1920×1080 pixels or less designated by the design template, as indicated by a broken line in FIG. 4B, by scaling or trimming. At Step 77, the image synthesis processor 21 expands as a next stage of image synthesis each image after being reduced in size onto the buffer 22 so as to be pasted to a region of the base-sheet image according the position and size designated by the design template.

When an image to be pasted is of an image size or less designated by the design template, at Step 74, the image size processor 35 maintains the image size of the image without reducing or expands the image size of the image to an image size designated by the design template.

As shown in FIG. 4C, when the image synthesis processor 21 generates a composite image for display 3d in which a predetermined number of images designated by the design template are pasted to the regions of the base-sheet image designated by the design template, the process progresses from Step 78 to Step 79. Then, the image synthesis processor 21 outputs uncompressed image data of the composite image for display on the buffer 22 to the HD video output unit 25 and displays the composite image for display on the display of the HDTV receiver 40.

The composite image for display may be displayed on the display of the HDTV receiver 40 for an appropriate time, and after the time elapses, image data of the composite image for display may be erased.

As described above, in generating the composite image for display, uncompressed image data of the base-sheet image and the images are transferred to the image synthesis processor 21 through the HD video interfaces 39 and 29 in real time, and the image synthesis processor 21 captures uncompressed image data. Therefore, when the user instructs to create a scrapbook, a composite image for display is immediately generated and displayed on the display of the HDTV receiver 40.

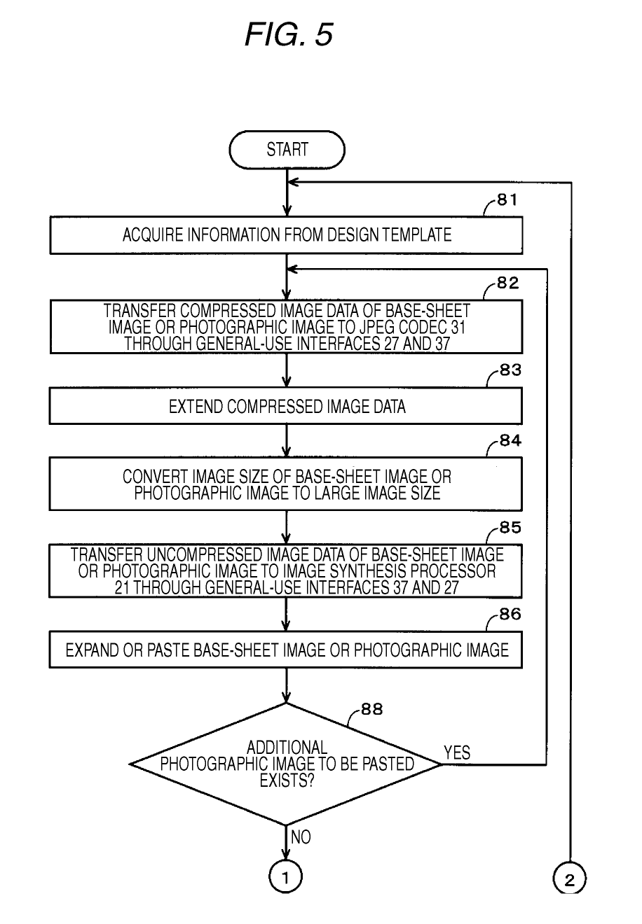

### (2-3. Example of Generation of Composite Image for Printing or Storage: FIGS. 5, 6, and 7)

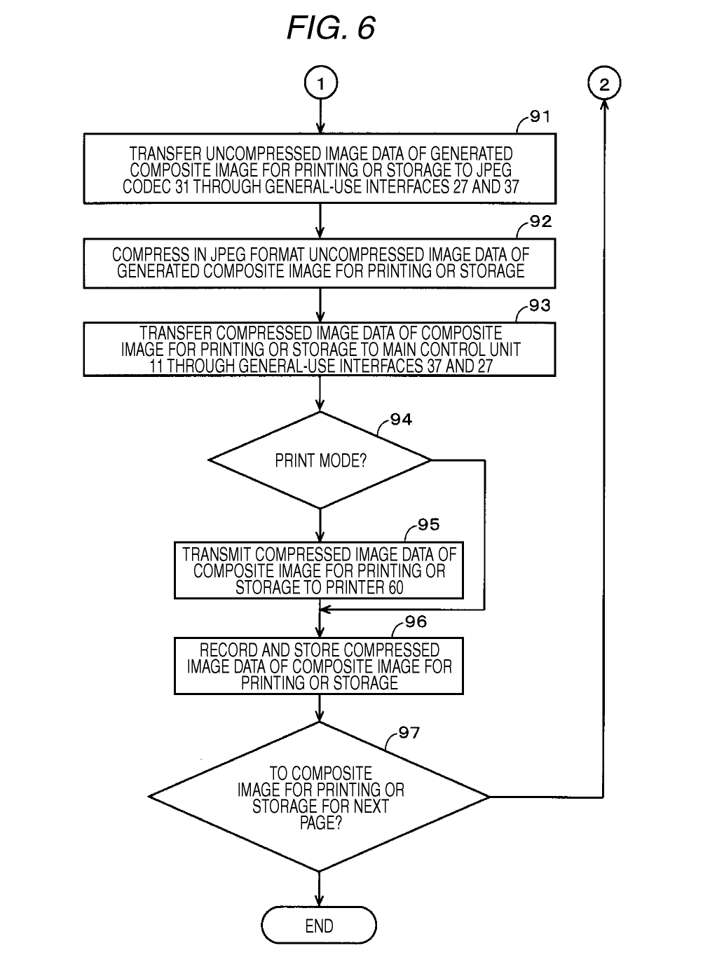

FIGS. 5 and 6 show an example of a series of processing regarding generation and printing or storage of a composite image for printing or storage, which is executed by the image processing apparatus 10.

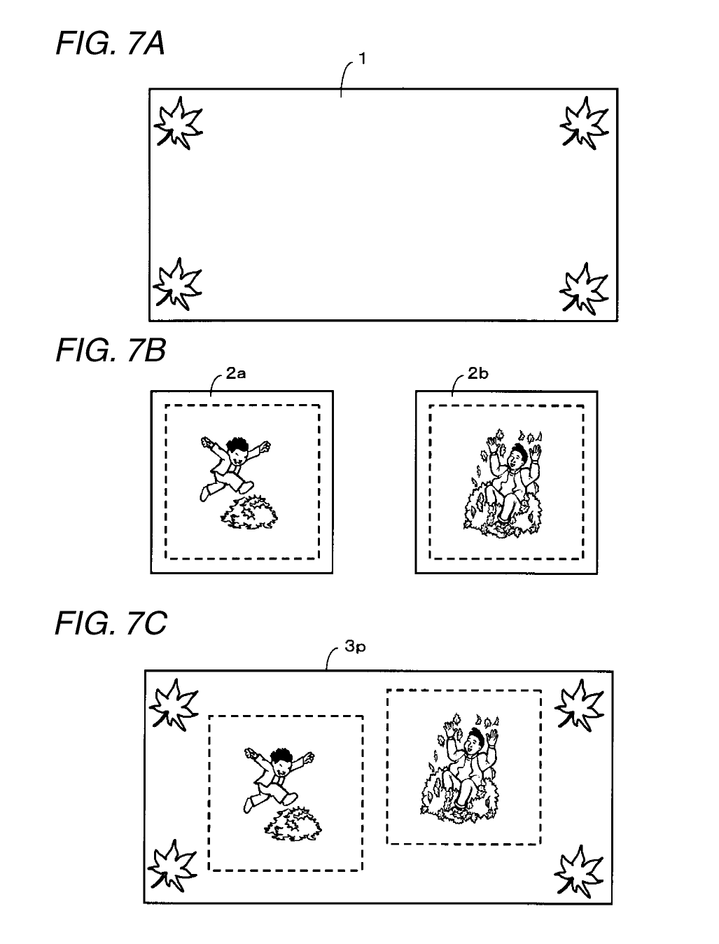

In this example, a design template is generated in the above-described manner, and after a composite image for display is generated, at Step 81, the main controller 11 first acquires information about a composite image of a first page from the design template. Next, at Step 82, the main controller 11 initially transfers compressed image data (JPEG file) of a base-sheet image 1 shown in FIG. 7A to the JPEG codec 31 through the general-use interfaces 27 and 37.

Next, at Step 83, the decoder 33 of the JPEG codec 31 extends compressed image data. Next, at Step 84, the image size processor 35 converts the image size of the base-sheet image represented by uncompressed image data after being extended to a large image size suitable for printing. Next, at Step 85, the image size processor 35 transfers uncompressed image data of the base-sheet image to the image synthesis processor 21 through the general-use interfaces 37 and 27.

Next, at Step 86, the image synthesis processor 21 expands the base-sheet image represented by transferred uncompressed image data onto the buffer 23 as a first stage of image synthesis.

Next, at Step 88, the image synthesis processor 21 determines whether or not an additional image to be pasted exists, and when no additional image exists, the process progresses from Step 88 to Step 91. Meanwhile, when an additional image exists, the process returns (progresses) from Step 88 to Step 82, and Steps 82 to 86 are executed for the image to be pasted.

In respects to the images 2a and 2b to be pasted shown in FIG. 7B, at Step 84, the image size processor 35 reduces the image size of each image represented by uncompressed image data after being extended to an image size or less of the base-sheet image designated by the design template, as indicated by a broken line in FIG. 7B, by scaling or trimming. At Step 86, the image synthesis processor 21 expands as a next stage of image synthesis each image after being reduced in size onto the buffer 23 so as to be pasted to a region of the base-sheet image according to the position and size designated by the design template.

When an image to be pasted is of an image size or less designated by the design template, at Step 84, the image size processor 35 maintains the image size of the image without reducing or expands the image size of the image to an image size designated by the design template.

As shown in FIG. 7C, when the image synthesis processor 21 generates a composite image for printing or storage 3p in which a predetermined number of images designated by the design template are pasted to regions of the base-sheet image designated by the design template, the process progresses from Step 88 to Step 91. Then, the image synthesis processor 21 transfers uncompressed image data of the composite image for printing or storage on the buffer 23 to the JPEG codec 31 through the general-use interfaces 27 and 37.

Next, at Step 92, the encoder 32 of the JPEG codec 31 compresses in a JPEG format uncompressed image data of the composite image for printing or storage. Next, at Step 93, compressed image data (JPEG file) of the composite image for printing or storage is transferred to the main controller 11 through the general-use interfaces 37 and 27.

Next, at Step 94, the main controller 11 determines whether or not the printer 60 is connected to the general-use interface 27 and a print mode in which printing is instructed by the user is activated. If the print mode is not activated, the process progresses from Step 94 to Step 96. Meanwhile, if the print mode is activated, the process progresses to Step 94 to Step 95, compressed image data (JPEG file) of the composite image for printing or storage transferred from the JPEG codec 31 in the above-described manner is transmitted to the printer 60 through the general-use interface 27, such that the printer 60 prints the composite image for printing or storage. Next, the process progresses to Step 96.

At Step 96, the main controller 11 controls the storage controller 15 to record and store compressed image data of the composite image for printing or storage in the HDD 16. When a DVD is loaded in the DVD drive 17 and the user instructs to record compressed image data in the DVD, the main controller 11 controls the storage controller 15 to record and store compressed image data of the composite image for printing or storage in the DVD. In addition, when the memory card 18 is installed in the card slot of the image processing apparatus 10 and the user instructs to record compressed image data in the memory card 18, the main controller 11 controls the storage controller 15 to record and store compressed image data of the composite image for printing or storage in the memory card 18.

Next, at Step 97, the main controller 11 determines whether or not to generate a composite image for printing or storage for a next page, and when it is determined not to generate the composite image for printing or storage for the next page, that is, when scrapbook creation is completed, ends a series of processing regarding generation and printing or storage of a composite image for printing or storage. Meanwhile, when it is determined to generate the composite image for printing or storage for the next page, the process returns (progresses) from Step 97 to Step 81, the main controller 11 causes the individual sections of the image processing apparatus 10 to execute Steps 81 to 96 regarding generation and printing or storage of the composite image for printing or storage for the next page.

In the foregoing example, even when a composite image for printing or storage is printed, the JPEG file of the composite image for printing or storage is stored. Alternatively, it may be configured such that by the user's instruction, the composite image for printing or storage is printed while the JPEG file of the composite image for printing or storage is not stored.

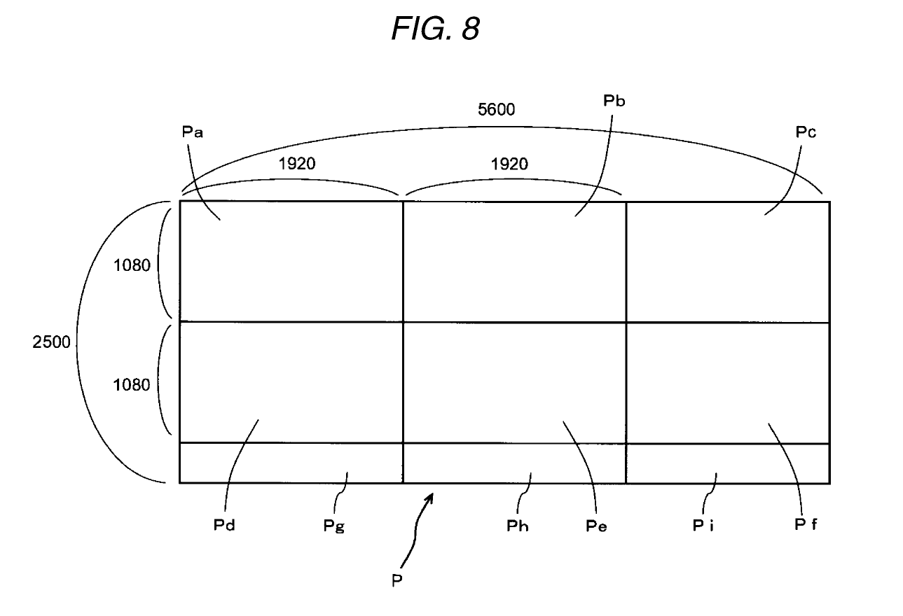

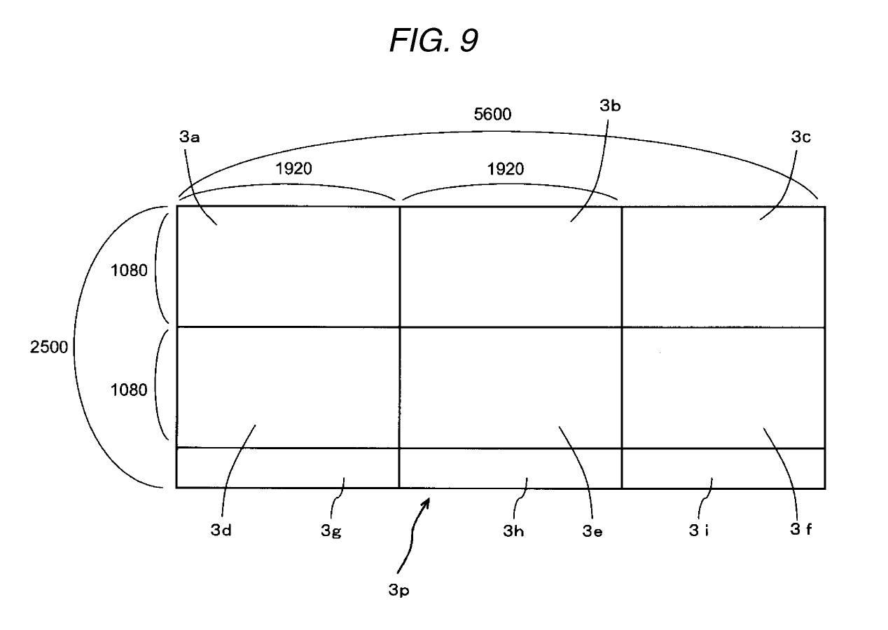

### (2-4. Other Examples of Generation of Composite Image for Printing or Storage: FIGS. 8 and 9)

In the foregoing example, in generating the composite image for printing or storage, at Step 85 of FIG. 5, the image size processor 35 transfers uncompressed image data of the base-sheet image and the images to the image synthesis processor 21 through the general-use interfaces 37 and 27, without converting the image size. In contrast, the image size processor 35 may divide the base-sheet image and the images of a large image size into a plurality of images of up to 1920×1080 pixels, and may sequentially transfer uncompressed image data of the divided images to the image synthesis processor 21 through the HD video interfaces 39 and 29.

For example, as shown in FIG. 8, when an image P is of 5600×2500 pixels, the image size processor 35 divides the image P of 5600×2500 pixels into nine images Pa, Pb, Pc, Pd, Pe, Pf, Pg, Ph, and Pi of up to 1920×1080 pixels, and sequentially transfers uncompressed image data of the divided images Pa to Pi to the image synthesis processor 21 through the HD video interfaces 39 and 29. The image synthesis processor 21 reconstructs the image and pastes the image to the base-sheet image.

According to this example, the number of transfer times is increased, but it is possible to transfer uncompressed image data of each divided image to the image synthesis processor 21 in real time. Therefore, it is possible to rapidly generate a composite image for printing or storage.

In the foregoing example, in generating the composite image for printing or storage, at Step 91 of FIG. 6, the image synthesis processor 21 transfers uncompressed image data of the generated composite image for printing or storage to the JPEG codec 31 through the general-use interfaces 27 and 37. And, at Step 92, the encoder 32 of the JPEG codec 31 compresses in a JPEG format uncompressed image data of the composite image for printing or storage. Alternatively, the image synthesis processor 21 may divide the generated composite image for printing or storage into a plurality of images of up to 1920×1080 pixels, and may sequentially transfer uncompressed image data of the divided images to the image size processor 35 through the HD video interfaces 29 and 39. And, the image size processor 35 reconstructs composite image for printing or storage by combining the divided images. In addition, the encoder 32 may compress uncompressed image data of the reconstructed composite image for printing or storage in a JPEG format.

For example, as shown in FIG. 9, when a composite image for printing or storage 3p is of 5600×2500 pixels, the image synthesis processor 21 divides the composite image 3p of 5600×2500 into nine images 3a, 3b, 3c, 3d, 3e, 3f, 3g, 3h, and 3i of up to 1920×1080, and sequentially transfers uncompressed image data of the divided images 3a to 3i to the image size processor 35 through the HD video interfaces 29 and 39. And, the image size processor 35 reconstructs the composite image 3p by combining the divided images 3a to 3i.

According to this example, the number of transfer times is increased, but it is possible to transfer uncompressed image data of each divided image to the image size processor 35 of the codec section 30 in real time. Therefore, it is possible to rapidly transmit compressed image data (JPEG file) of the composite image for printing or storage to the printer 60.

### [3. Other Examples or Embodiments]

Although in the foregoing example, a composite image is generated by pasting images to a base-sheet image, still images to be pasted to the base-sheet image may be images obtained from an original document read by a scanner.

Although in the example of FIG. 1, the composite image for display generated by the image processing apparatus 10 is displayed on the display of the HDTV receiver 40, in respects to the image system, the composite image for display generated by the image processing apparatus 10 may be displayed on an image display device not having a tuner.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
a decoder that extends compressed image data of a still image to be synthesized;
an image size processor that executes image processing regarding an image size on uncompressed image data as the output from the decoder;
a general-use interface that transfers uncompressed image data as the output from the decoder or the image size processor, and has a relatively low transmission speed;
an exclusive-use interface that transfers uncompressed image data as the output from the decoder or the image size processor, and has a relatively high transmission speed;
an image synthesis processor that generates uncompressed image data of a composite image for display of a relatively small image size by image synthesis on the basis of uncompressed image data transferred through the exclusive-use interface, and generates uncompressed image data of a composite image for printing or storage of a relatively large image size by image synthesis on the basis of uncompressed image data transferred through the general-use interface or the exclusive-use interface; and
an encoder that compresses uncompressed image data of the generated composite image for printing or storage.

2. The image processing apparatus according to claim 1,
wherein, in generating the composite image for printing or storage, the image synthesis processor generates composite image for printing or storage on the basis of uncompressed image data of the still image to be synthesized, which is transferred through the general-use interface.

3. The image processing apparatus according to claim 1,
wherein, in generating the composite image for printing or storage, the image size processor divides the still image to be synthesized into a plurality of images of an image size or less corresponding to the composite image for display, and sequentially transfers uncompressed image data of the divided images to the image synthesis processor through the exclusive-use interface, and
the image synthesis processor reconstructs the still image to be synthesized on the basis of the divided images to generate the composite image for printing or storage.

4. The image processing apparatus according to claim 1,
wherein, in generating the composite image for printing or storage, the image synthesis processor transfers uncompressed image data of the generated composite image for printing or storage to the encoder through the general-use interface.

5. The image processing apparatus according to claim 1,
wherein, in generating the composite image for printing or storage, the image synthesis processor divides the generated composite image for printing or storage into a plurality of images of an image size or less corresponding to the composite image for display, and sequentially transfers the divided images to the image size processor through the exclusive-use interface, and
the image size processor reconstructs the composite image for printing or storage on the basis of the divided images, and transfers uncompressed image data of the composite image for printing or storage to the encoder.

6. An image processing method in an image processing apparatus, which includes a general-use interface having a relatively low transmission speed and an exclusive-use interface having a relatively high transmission speed, the image processing method comprising the steps of:
converting the image size of a still image to be synthesized to be equal to or less than a relatively small first image size;
acquiring uncompressed image data of the still image to be synthesized after being converted to the first image size or less through the exclusive-use interface, and generating uncompressed image data of the composite image for display of the first image size;
converting the image size of the still image to be synthesized to be equal to or less than a second image size which is larger than the first image size;
acquiring uncompressed image data of the still image to be synthesized after being converted to the second image size or less through the general-use interface or the exclusive-use interface, and generating uncompressed image data of the composite image for printing or storage of the second image size; and
compressing uncompressed image data of the generated composite image for printing or storage.
